(19) United States
(12) Patent Application Publication
(10) Pub. No.: US 2016/0178924 A1
(43) Pub. Date: Jun. 23, 2016

(54) CAMERA MODULE

(71) Applicant: Samsung Electro-Mechanics Co., Ltd., Suwon-si (KR)

(72) Inventors: Soo Cheol LIM, Suwon-si (KR); Chuel Jin PARK, Suwon-si (KR); Chul Jin KIM, Suwon-si (KR)

(73) Assignee: Samsung Electro-Mechanics Co., Ltd., Suwon-si (KR)

(21) Appl. No.: 14/934,622

(22) Filed: Nov. 6, 2015

(30) Foreign Application Priority Data
Dec. 19, 2014 (KR) 10-2014-0184781

(51) Int. Cl. G02B 27/64; G02B 7/04

(52) U.S. Cl. CPC G02B 27/646; G02B 7/04

(57) ABSTRACT

A camera module includes: a bobbin; a lens barrel mounted in the bobbin; a holder containing the bobbin; a lens driver including a first coil disposed on an outer surface of the bobbin, a magnet facing the first coil, and a second coil facing the magnet; a frame spaced apart from the holder; and a ball bearing part disposed between the holder and the frame, wherein the first coil and the magnet are configured to generate a first driving force in an optical axis direction, and wherein the second coil and the magnet are configured to generate a second driving force in a direction perpendicular to the optical axis direction.

### CROSS-REFERENCE TO RELATED APPLICATION(S)

This application claims the benefit of Korean Patent Application No. 10-2014-0184781 filed on Dec. 19, 2014, in the Korean Intellectual Property Office, the entire disclosure of which is incorporated herein by reference for all purposes.

### BACKGROUND

1. Field

The following description relates to a camera module.

2. Description of Related Art

Recently, multi-functional subminiature camera modules have been used in mobile communications terminals such as tablet personal computers (PCs), laptop computers, and the like, in addition to mobile phones such as smartphones.

In addition, single-focus type camera modules that photograph subjects by a fixed focus may be implemented into camera modules. Recently, however, with technological advancements, a camera module including an autofocus (AF) actuator which may perform autofocus control has been implemented.

Further, as mobile communications terminals are becoming increasingly smaller, mobile communications terminals are significantly affected by slight movement thereof when an image is photographed, and thus image quality may deteriorate. Therefore, image stabilization technology is required to obtain clear images.

When shaking of the hand occurs during photographing of an image, an optical image stabilization (OIS) actuator to which an OIS technology is applied may be used for image stabilization.

The OIS actuator may move a lens module in a direction perpendicular to an optical axis direction. To this end, the OIS actuator uses a suspension wire which supports the lens module.

However, since the suspension wire used in the OIS actuator is vulnerable to external impacts, the suspension wire is likely to be deformed during the driving of the OIS. As a result, driving displacement may occur, and thus it is difficult to provide product reliability.

Further, when a camera module includes an AF actuator and an OIS actuator, it is difficult to miniaturize the camera module, and manufacturing costs may rise.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a camera module includes: a bobbin; a lens barrel mounted in the bobbin; a holder containing the bobbin; a lens driver including a first coil disposed on an outer surface of the bobbin, a magnet facing the first coil, and a second coil facing the magnet; a frame spaced apart from the holder; and a ball bearing part disposed between the holder and the frame, wherein the first coil and the magnet are configured to generate a first driving force in an optical axis direction, and wherein the second coil and the magnet are configured to generate a second driving force in a direction perpendicular to the optical axis direction.

The camera module may further include: a first substrate including an image sensor mounted thereon and coupled to the frame; and a suspension wire including a first end fixed to the first substrate and a second end fixed to the holder.

The holder may include at least one elastic member elastically supporting the lens barrel.

The second end of the suspension wire may be fixed to the elastic member.

The first coil and the magnet may face each other in the direction perpendicular to the optical axis direction.

The second coil and the magnet may face each other in the direction perpendicular to the optical axis direction.

A first surface of the magnet facing the first coil and a second surface of the magnet facing the second coil may have different poles.

The first coil may be wound around the outer surface of the bobbin in one direction, and the second coil may have a donut shape including a hollow.

The magnet may be mounted on the holder.

The camera module may further include: a case enclosing the holder and coupled to the frame; and a second substrate mounted on an inner surface of the case, wherein the second coil is mounted on the second substrate.

The ball bearing part may contact and support the frame and the holder.

The frame may include an accommodating groove in which the ball bearing part is disposed.

According to another general aspect, a camera module includes: a frame including a window configured to transmit light therethrough; a driving part spaced apart from the frame; a lens barrel disposed in the frame; a ball bearing part disposed between the frame and the driving part; a magnet disposed in the driving part; a first coil configured to interact with the magnet to generate a driving force in an optical axis direction; and a second coil configured to interact with the magnet to generate a driving force in a direction perpendicular to the optical axis direction.

The magnet may be disposed between the first coil and the second coil.

The first coil and the magnet may face each other in the direction perpendicular to the optical axis direction, and the magnet and the second coil may face each other in the direction perpendicular to the optical axis direction.

The camera module may further include: a first substrate including an image sensor mounted thereon and coupled to the frame; and a suspension wire including a first end fixed to the first substrate and a second end fixed to the driving part.

The suspension wire may be configured to supply power to the first coil.

The ball bearing part may be configured to prevent tilting of the driving part due to deformation of the suspension wire.

Other features and aspects will be apparent from the following detailed description, the drawings, and the claims.

### BRIEF DESCRIPTION OF THE DRAWINGS

FIG. 1 is a schematic exploded perspective view of a camera module according to an example.

FIG. 2 is a perspective view of the camera module.

FIG. 3 is a diagram illustrating a form in which a ball bearing is disposed between a holder and a frame of the camera module.

FIG. 4 is a schematic cross-sectional view of the camera module.

FIG. 5 is a schematic perspective view illustrating a configuration of a lens driver of the camera module.

FIG. 6 is a cross-sectional view taken along line A-A′ of FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

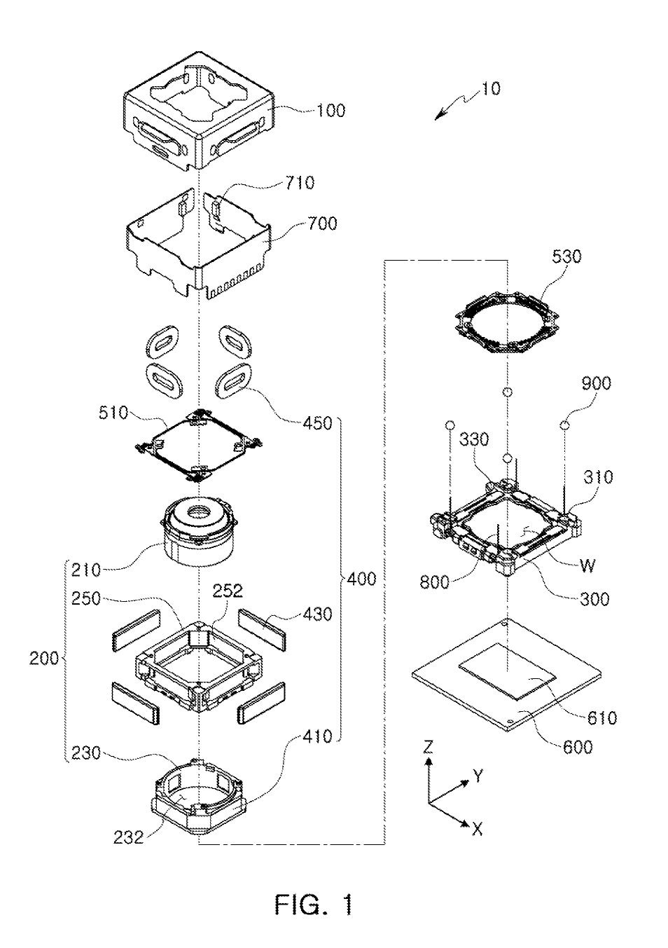

Terms will be defined with respect to directions in the following description. As viewed in FIG. 1, an optical axis direction (Z direction) refers to a vertical direction in relation to a lens barrel 210.

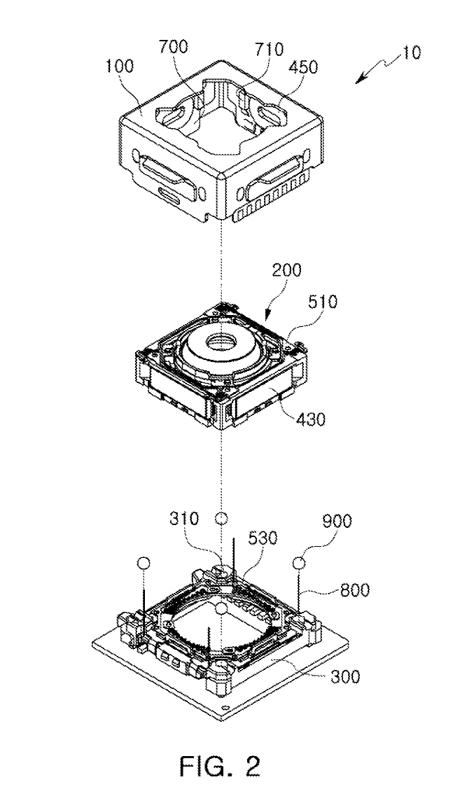

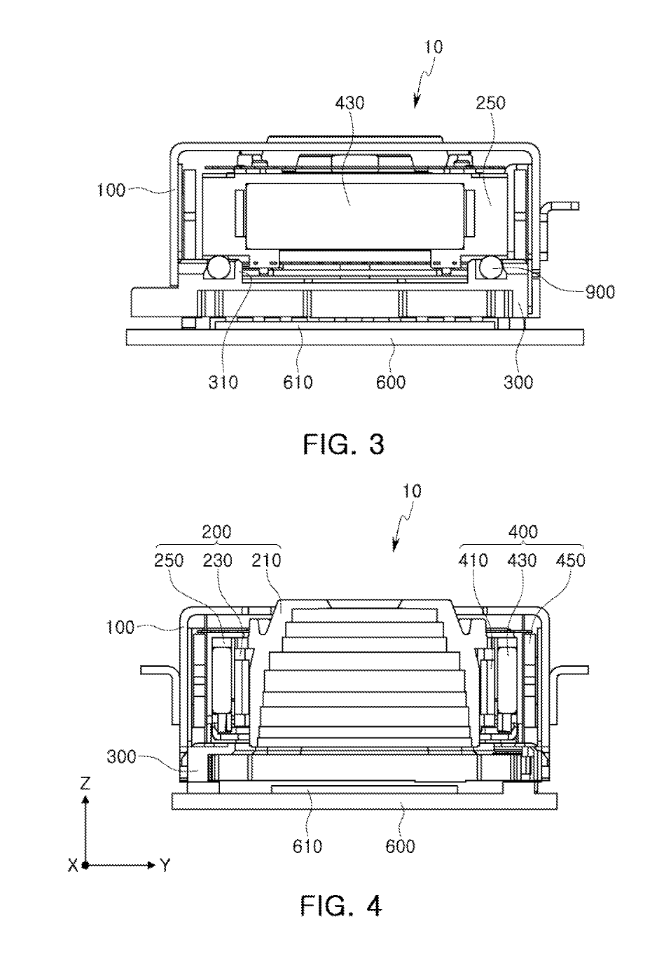

FIG. 1 is a schematic exploded perspective view of a camera module 10 according to an example. FIG. 2 is a perspective view illustrating the camera module 10 in a partially assembled state. FIG. 3 is a diagram illustrating a form in which a ball bearing is disposed between a holder 250 and a frame 300, according to an example.

Referring to FIG. 1, the camera module 10 includes the lens barrel 210, a bobbin 230 in which the lens barrel 210 is mounted, a holder 250 in which the bobbin 230 is retained, a lens driver 400 configured to drive the bobbin 230 and the holder 250, a frame 300 spaced apart from the holder 250 in the optical axis direction (Z direction), and a case 100 coupled to the frame 300.

The lens barrel 210 may have a hollow cylindrical shape in order to accommodate a plurality of lenses used to photograph subjects, and the plurality of lenses may be provided in the lens barrel 210 along an optical axis. The plurality of lenses may include a required number of lenses stacked depending on a design of the lens barrel 210, and each of the lenses may have optical characteristics such as the same or different reflective indices, or the like.

The lens barrel 210 is coupled to the bobbin 230. For example, the lens barrel 210 is fixedly inserted into a hollow 232 of the bobbin 230. The bobbin 230 is disposed inside the holder 250 along with the lens barrel 210 and is configured to be driven inside the holder 250 in the optical axis direction (Z direction) for autofocusing. Further, the holder 250 is configured to be driven in directions (X and Y directions) perpendicular to the optical axis direction (Z direction) for image stabilization in a state in which the bobbin 230 and the lens barrel 210 are disposed inside the holder 250. In this configuration, the lens barrel 210, the bobbin 230, and the holder 250 are configured to operate as a driving part 200 driven to perform autofocusing and image stabilization.

The frame 300 is spaced apart from the driving part 200 in the optical axis direction (Z direction), and includes a window W through which light is transmitted. Further, a first substrate 600 on which an image sensor 610 is mounted is coupled to a lower part of the frame 300.

The case 100 is coupled to the frame 300 to enclose the driving part 200, and is configured to shield electromagnetic waves generated during the driving of the camera module. That is, electromagnetic waves may be generated when the camera module is driven, and the electromagnetic waves, when externally discharged, may have an influence on other electronic components, thereby causing communications errors or malfunctions. Accordingly, the case 100 may be formed of a metal material and may be grounded to a ground pad (not shown) provided on the first substrate 600 in order to shield electromagnetic waves.

Alternatively, when the case 100 is formed of a plastic injection-molded product, a conductive paint may be applied onto an inner surface of the case 100 to shield electromagnetic waves. The conductive paint may be a conductive epoxy, but is not limited thereto. That is, various materials having conductivity may be used as the conductive paint. Additionally, instead of using a conductive paint, a conductive film or conductive tape may be attached to the inner surface of the case 100.

The lens driver 400 is configured to drive the bobbin 230 in the optical axis direction (Z direction) or to drive the holder 250 in directions (X and Y directions) perpendicular to the optical axis direction (Z direction). The lens driver 400 includes a first coil 410, a magnet 430, and a second coil 450. The magnet 430 may include multiple magnet members, and the second coil 450 may include multiple coil members.

First, describing the autofocusing driving, the first coil 410 is mounted on an outer surface of the bobbin 230, and the magnet 430 is disposed on the holder 250 to face the first coil 410. The holder 250 includes open sides 252 so that the magnet 430 and the first coil 410 may face each other. Accordingly, the magnet 430 is mounted on the open sides 252 of the holder 250 to face the first coil 410 in directions (X and Y directions) perpendicular to the optical axis direction (Z direction).

The magnet 430 generates a predetermined magnetic field, and when power is applied to the first coil 410, a driving force is generated by an electromagnetic influence between the magnet 430 and the first coil 430, thereby moving the bobbin 230 and the lens barrel 210 in the optical axis direction (Z direction) inside the holder 250. The bobbin 230 and the lens barrel 210 are moved by the aforementioned operation to perform an autofocus or zoom function.

The holder 250 includes one or more elastic members 510 and 530 elastically supporting the bobbin 230. For example, the first elastic member 510 is disposed on an upper portion of the holder 250 to elastically support the bobbin 230, and the second elastic member 530 is disposed on a lower portion of the holder 250 to elastically support the bobbin 230.

Next, the driving for image stabilization will be described.

Image stabilization is implemented to compensate for blurring of an image or shaking of a video occurring due to factors such as shaking of a user's hand when the image is photographed and the video is recorded. For example, when shaking of the hand occurs, a relative displacement may be imparted to the holder in directions (X and Y directions) perpendicular to the optical axis direction (Z direction), thereby performing image stabilization.

The second coil 450 is disposed to face the magnet 430. For example, the second coil 450 is mounted on a second substrate 700 attached to an inner surface of the case 100 to face the magnet 430 in directions (X and Y directions) perpendicular to the optical axis direction (Z direction). A hall sensor 710 is mounted on the second substrate 700 in a position adjacent to the second coil 450 to sense a position of the magnet 430.

The magnet 430 generates a predetermined magnetic field, and when power is applied to the second coil 450, a driving force is generated by an electromagnetic influence between the magnet 430 and the second coil 450, thereby moving the holder 250 in directions (X and Y directions) perpendicular to the optical axis direction (Z direction) by the driving force. Since the lens barrel 210 and the bobbin 230 are disposed in the holder 250, the lens barrel 210 and the bobbin 230 are also driven in directions (X and Y directions) perpendicular to the optical axis direction (Z direction) by the driving of the holder 250. The holder 250 is moved by the aforementioned operation to perform image stabilization.

A suspension wire 800 is provided to support the driving of the driving part 200 in directions (X and Y directions) perpendicular to the optical axis direction (Z direction) One end of the suspension wire 800 is fixed to the first substrate 600, and the other end of the suspension wire 800 is fixed to the first elastic member 510 of the driving part 200. Accordingly, the suspension wire 800 provides a gap between the driving part 200 and the frame 300 such that the driving part 200 and the frame 300 are spaced apart from each other in the optical axis direction (Z direction). A total number of four suspension wires 800 may be provided and disposed in respective corners of the frame 300 to support the driving of the driving part 200 when image stabilization is performed.

The suspension wire 800 is also configured to supply power to the first coil 410. Since one end of the suspension wire 800 is connected to the first substrate 410, the other end of the suspension wire 800 is connected to the first elastic member 510, and the first elastic member 510 is connected to a lead wire of the first coil 410, the first coil 410 is configured to receive power through the suspension wire 800.

As illustrated in FIG. 3, a ball bearing part 900 is disposed between the driving part 200 and the frame 300. For example, the ball bearing part 900 is disposed between the frame 300 and the holder 250 containing the driving part 200, to contact and support the holder 250 and the frame 300.

When shaking of the user's hand occurs, the driving part 200 moves in directions (X and Y directions) perpendicular to the optical axis direction (Z direction) by the magnet 430 and the second coil 450, thereby performing image stabilization. When the driving part 200 is driven in directions (X and Y directions) perpendicular to the optical axis direction (Z direction), the suspension wire 800 may be deformed to be curved, bent, or the like. Accordingly, the driving part 200 may be inclined, and thus a driving tilt may occur. Further, even when external impacts such as those resulting from the mobile communications terminal falling to the ground occur, a driving tilt is likely to occur due to the deformation of the suspension wire 800.

Therefore, the ball bearing part is provided between the driving part 200 and the frame 300 in order to prevent driving tilt due to deformation of the suspension wire 800. Since the suspension wire 800 supports the driving part 200 in a state in which the driving part 200 and the frame 300 are spaced apart from each other in the optical axis direction (Z direction), and the ball bearing part 900 is disposed in the gap between the driving part 200 and the frame 300 in the optical axis direction (Z direction), the gap between the driving part 200 and the frame 300 is maintained by the suspension wire 800 and the ball bearing part 900.

Furthermore, since one end and the other end of the suspension wire 800 are respectively fixed to the first substrate 600 and the first elastic member 510, the ball bearing part 900 maintains contact with the driving part 200 and the frame 300 and is not separated from the driving part 200 and the frame 300. Further still, since the driving part 200 is supported by the ball bearing part 900 in the state in which the driving part 200 maintains the gap from the frame 300 in the optical axis direction (Z direction), even though external impacts or the like may occur, the suspension wire 800 is prevented from being deformed. Therefore, the driving part 200 may be stably moved in parallel with directions (X and Y directions) perpendicular to the optical axis direction (Z direction).

The frame 300 includes an accommodating groove 310 in which the ball bearing part 900 is disposed. The accommodating groove 310 is concavely formed on an upper surface of the frame 300, and the ball bearing part 900 partially protrudes from the accommodating groove 310 while being disposed in the accommodating groove 310. Therefore, the ball bearing part 900 contacts the driving part 200 and the frame 300.

A size of the accommodating groove 310 is larger than a diameter of the ball bearing part 900. Therefore, the ball bearing part 900 is allowed to roll within the accommodating groove 310 while contacting the driving part 200 and the frame 300. Since the driving part 200 maintains the state in which it comes in point contact with the ball bearing part 900, the driving part 200 is configured to be stably driven in directions (X and Y directions) perpendicular to the optical axis direction (Z direction).

In addition, since the driving part 200 contacts and is supported by the ball bearing part 900, even though external impacts or the like may occur, deformation or fracturing of the suspension wire 800 may not occur. Accordingly, driving characteristics and durability of the driving part 200 when image stabilization is performed may be improved. The ball bearing part 900 may include at least three ball bearings. In the example shown and described herein, four ball bearings are provided, but the concept of the disclosure is not limited to a particular number, spacing or arrangement of ball bearings. When three ball bearings are provided, the three ball bearings may be, for example, spaced apart from one another at an interval of 120° in relation to the optical axis.

A yoke part 330, which is formed of a magnetic material, is provided in the camera module 10 facing the magnet 430 in the optical axis direction (Z direction), and is mounted on the frame 300. For example, since the yoke part 330 is formed of a magnetic material, magnetic attraction is applied between the yoke part 330 and the magnet 430 in the optical axis direction (Z direction).

Since the yoke part 330 is a fixed member, the magnet 430 is pulled toward the yoke part 330 by magnetic attraction. Accordingly, the holder 250 on which the magnet 430 is mounted is pulled toward the frame 300.

Therefore, the ball bearing part 900 may maintain contact with the driving part 200 and the frame 300 and may not move out from between the driving part 200 and the frame 300. Accordingly, even if external impacts or the like occur, the gap between the frame 300 and the driving part 200 may be maintained, and therefore the camera module 10 may provide reliability when external impacts or the like occur.

Further, a space around the magnet 430 to which a magnetic field is applied is relatively decreased by the yoke part 330. For example, a path of a closed circuit formed by lines of magnetic force starting from an N pole of the magnet 430 and returning to an S pole of the magnet 430 is shortened by the yoke part 330.

Without a yoke part 330, a magnetic field of the magnet 430 may be applied to a relatively large space, but with the yoke part 330, the magnetic field of the magnet 430 passes through the yoke part 330, and thus the magnetic field of the magnet 430 is applied to a relatively smaller space. In other words, the lines of magnetic force start from the N pole of the magnet 430 and return to the S pole through the yoke part 330, and thus, the path of the closed circuit formed by the lines of magnetic force are shortened.

When the camera module 10 is equipped in portable electronic devices such as smartphones, the magnetic field of the magnet 430 included in the camera module 10 may be influenced by other magnetic materials included in the portable electronic devices. Therefore, the magnetic field of the magnet 430 may be influenced by an external magnetic field during the driving for image stabilization, and thus the holder 250 may malfunction or may not be driven to an accurate position. However, in the camera module 10, the yoke part 330 faces the magnet 430 in the optical axis direction (Z direction), and thus the magnetic field of the magnet 430 is applied to a relatively smaller space, thereby reducing the influence of the external magnetic field at the time of the driving for image stabilization.

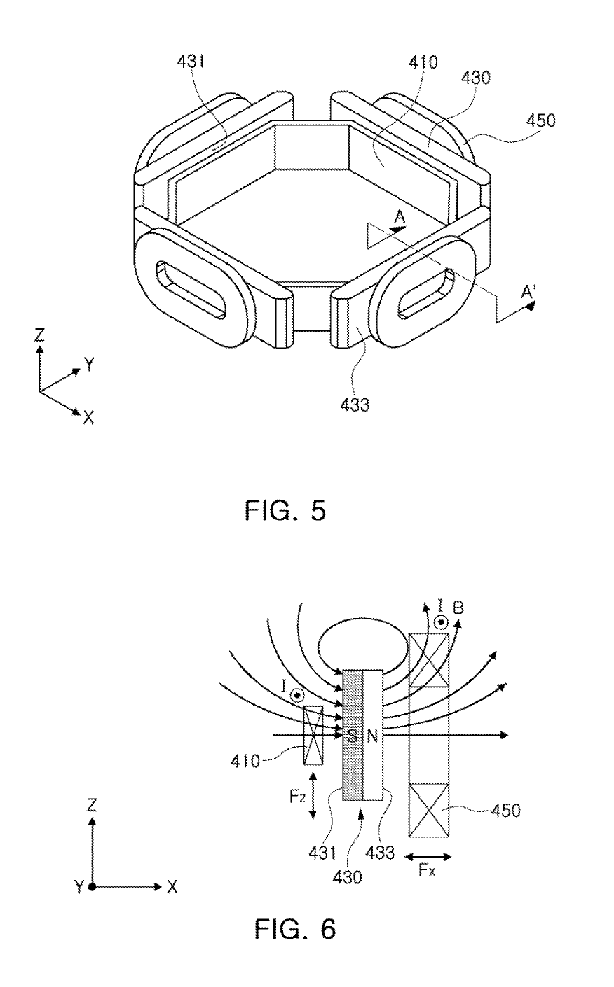

FIG. 4 is a schematic cross-sectional view of the camera module 10, FIG. 5 is a schematic perspective view illustrating a configuration of the lens driver 400, and FIG. 6 is a cross-sectional view taken along line A-A′ of FIG. 5.

The configuration of the lens driver 400 will be described with reference to FIGS. 4 through 6.

As described above, the lens driver 400 includes the first coil 410, the magnet 430, and the second coil 450. The first coil 410 is wound around the outer surface of the bobbin 230 in one direction, and the magnet 430 is mounted on the holder 250 to face the first coil 410 in directions (X and Y directions) perpendicular to the optical axis (Z direction). Therefore, as illustrated in FIGS. 4 and 5, the magnet 430 is disposed between the first coil 410 and the second coil 450, and the magnet 430 includes a first surface 431 facing the first coil 410 and a second surface 433 facing the second coil 450.

The magnet 430 is used for both the driving for the auto focusing and the driving for image stabilization. For example, in the lens driver 400, a magnet for the driving for the auto focusing and a magnet for the driving for image stabilization are not separately provided, but the magnet 430 is used for both the driving for the autofocusing and the driving for image stabilization, thereby allowing the camera module 10 to be miniaturized. That is, the lens driver 400 implements both the autofocusing and image stabilization functions to reduce the number of components for implementing the autofocusing and image stabilization functions, thereby allowing the camera module 10 to be miniaturized.

The first surface 431 and the second surface 433 of the magnet 430 have different poles. For example, the first surface 431 of the magnet 430 may have an S pole, and the second surface 433 of the magnet 430 may have an N pole.

First, a direction of electromagnetic force affected by an interaction between the first coil 410 and the magnet 430 during the driving for the autofocusing will be described with reference to FIG. 6.

A magnetic field B of the magnet 430 is applied to the first coil 410 in an X direction. When power is supplied to the first coil 410, a current I flows in a Y direction, and a direction (X direction) of a magnetic field B of the magnet 430 is orthogonal to a direction (Y direction) in which the current I flows from the first coil 410, and thus an electromagnetic force Fz is applied in a Z direction by the interaction between the first coil 410 and the magnet 430. Accordingly, the bobbin 230 is driven in the optical axis direction (Z direction) by the first coil 410 and the magnet 430.

Next, a direction of electromagnetic force affected by an interaction between the second coil 450 and the magnet 430 during the driving for the image stabilization will be described.

The magnetic field B of the magnet 430 is applied to the second coil 450 in a Z direction. When power is supplied to the second coil 450, the current I flows in the Y direction, the direction (Z direction) of the magnetic field B of the magnet 430 is orthogonal to the direction (Y direction) in which the current I flows from the second coil 450, and thus an electromagnetic force Fx is applied in the X direction by the interaction between the second coil 450 and the magnet 430. Accordingly, the holder 250 is driven in directions (X and Y directions) perpendicular to the optical axis direction (Z direction) by the second coil 450 and the magnet 430.

For convenience of explanation, the electromagnetic force Fx has been described to be applied in the X direction during the driving for the image stabilization, but description of an electromagnetic force Fy applied in the Y direction is the same as the foregoing description.

As set forth above, the camera module 10 may be miniaturized while having autofocusing and image stabilization functions.

Further, the camera module 10 prevents driving displacement from occurring during image stabilization while providing reliability when external impacts occur.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a bobbin;
a lens barrel mounted in the bobbin;
a holder containing the bobbin;
a lens driver comprising a first coil disposed on an outer surface of the bobbin, a magnet facing the first coil, and a second coil facing the magnet;
a frame spaced apart from the holder; and
a ball bearing part disposed between the holder and the frame,
wherein the first coil and the magnet are configured to generate a first driving force in an optical axis direction, and
wherein the second coil and the magnet are configured to generate a second driving force in a direction perpendicular to the optical axis direction.

2. The camera module of claim 1, further comprising:
a first substrate comprising an image sensor mounted thereon and coupled to the frame; and
a suspension wire comprising a first end fixed to the first substrate and a second end fixed to the holder.

3. The camera module of claim 2, wherein the holder comprises at least one elastic member elastically supporting the lens barrel.

4. The camera module of claim 3, wherein the second end of the suspension wire is fixed to the elastic member.

5. The camera module of claim 1, wherein the first coil and the magnet face each other in the direction perpendicular to the optical axis direction.

6. The camera module of claim 5, wherein the second coil and the magnet face each other in the direction perpendicular to the optical axis direction.

7. The camera module of claim 1, wherein a first surface of the magnet facing the first coil and a second surface of the magnet facing the second coil have different poles.

8. The camera module of claim 1, wherein the first coil is wound around the outer surface of the bobbin in one direction, and the second coil has a donut shape including a hollow.

9. The camera module of claim 1, wherein the magnet is mounted on the holder.

10. The camera module of claim 9, further comprising:
a case enclosing the holder and coupled to the frame; and
a second substrate mounted on an inner surface of the case,
wherein the second coil is mounted on the second substrate.

11. The camera module of claim 1, wherein the ball bearing part contacts and supports the frame and the holder.

12. The camera module of claim 1, wherein the frame comprises an accommodating groove in which the ball bearing part is disposed.

13. A camera module, comprising:
a frame comprising a window configured to transmit light therethrough;
a driving part spaced apart from the frame;
a lens barrel disposed in the frame;
a ball bearing part disposed between the frame and the driving part;
a magnet disposed in the driving part;
a first coil configured to interact with the magnet to generate a driving force in an optical axis direction; and
a second coil configured to interact with the magnet to generate a driving force in a direction perpendicular to the optical axis direction.

14. The camera module of claim 13, wherein the magnet is disposed between the first coil and the second coil.

15. The camera module of claim 13, wherein the first coil and the magnet face each other in the direction perpendicular to the optical axis direction, and wherein the magnet and the second coil face each other in the direction perpendicular to the optical axis direction.

16. The camera module of claim 13, further comprising:
a first substrate comprising an image sensor mounted thereon and coupled to the frame; and
a suspension wire comprising a first end fixed to the first substrate and a second end fixed to the driving part.

17. The camera module of claim 16, wherein the suspension wire is configured to supply power to the first coil.

18. The camera module of claim 16, wherein the ball bearing part is configured to prevent tilting of the driving part due to deformation of the suspension wire.
